(19) United States
(12) Patent Application Publication
(10) Pub. No.: US 2008/0200643 A1
(43) Pub. Date: Aug. 21, 2008

(54) METHOD FOR REDUCING THE CONTENT OF FLUORESCENT PARTICLES IN POLYCARBONATE

(75) Inventors: Pieter Ooms, Krefeld (DE); Alexander Karbach, Krefeld (DE); Alexander Meyer, Duesseldorf (DE)

Correspondence Address: CONNOLLY BOVE LODGE & HUTZ, LLP, P O BOX 2207, WILMINGTON, DE, 19899, US

(73) Assignee: Bayer MaterialScience AG, Liverkusen (DE)

(21) Appl. No.: 12/032,259

(22) Filed: Feb. 15, 2008

(30) Foreign Application Priority Data
Feb. 15, 2007 (DE) 102007007462.1

(51) Int. Cl. C08F 6/28

(52) U.S. Cl. 528/482

(57) ABSTRACT

A method for reducing the content of fluorescent particles in polycarbonate is disclosed. The method entails bringing into contact polycarbonate, in the melt or in solution, with aluminosilicate at a temperature and for a time calculated to obtain polycarbonate having fluorescent particles content of 0 to 5 counts/g of polycarbonate. In a preferred embodiment the polycarbonate is passed through a column packed with zeolite.

### FIELD OF THE INVENTION

The present invention relates to polycarbonates and in particular to reducing their content of fluorescent particles.

### TECHNICAL BACKGROUND OF THE INVENTION

Polycarbonate is prepared, for example, by the interfacial process or the melt transesterification process.

In the interfacial process, dihydroxy compounds are reacted with carbonyl dichloride in a two-phase mixture comprising an aqueous alkali hydroxide solution and an organic solvent. The reaction and phase separation are followed by washing steps for removing salts that are present from the polymer solution. The organic solvent is generally separated off by steps of thermal concentration by evaporation, which leads to a considerable thermal load on the polycarbonate. Polycarbonate may be damaged, inter alia, also by the action of hot metal surfaces and/or by contact with the atmosphere and/or by contact with salts, catalyst residues, etc., which results in a reduction in the quality of the polycarbonate.

In the melt transesterification process too, in which dihydroxy compounds are reacted with diaryl carbonates to form polycarbonates, polycarbonate is subjected to a high thermal load. As outlined above, polycarbonate may be damaged by contact with hot metal surfaces, salts, catalyst residues. This is true especially in the case of relatively long dwell times.

Furthermore, during the production of polycarbonate, it may be that, because of breakdowns in production, a polycarbonate melt that has already undergone various stages of concentration by evaporation must be dissolved in a solvent again. Once the breakdown in operation has been rectified, the polycarbonate is fed to concentration by evaporation again and is accordingly subjected to heat several times.

Polycarbonates are also subjected to heat by thermal processing methods such as extrusion or injection molding, which may likewise result in damage. In the recycling of extrudates or injection-molded parts, the thermal processing steps to which the material is repeatedly subjected, for example extrusion, may damage the material to such an extent that it may no longer be used for high-quality goods that require high optical quality. Consequently, the material frequently no longer meets the demands made for the production of, for example, transparent products such as optical data carriers, lenses, disks, etc.

It has been found that polycarbonate contains troublesome fluorescent particles and is accordingly not suitable for the production of molded parts that require high optical quality.

WO 2003020805 describes, for example, the working up of polycarbonate by the addition of short-chained OH-functionalized oligomers to the recycling material and condensation. This invention relates to the working-up of damaged polycarbonate, which was influenced only negligibly in terms of molecular weight.

WO 2003066704 describes epoxy-functionalized methacrylic acid derivatives which are added to damaged polycarbonate and condensed.

In order to improve the quality of thermoplastics, filtration of, inter alia, the materials used and/or the polymer solution and/or the polymer melt, for example, is carried out. This is described, for example, in EP-A 0806281 and EP-A 0220324 or in EP-A 1199325.

DE-A 4312391 discloses the purification of polycarbonate solutions using aluminosilicates. DE-A 4312391 describes the separation of substances with low molecular weight like bisphenol A or diphenylcarbonate or phenol. In contrast this present invention describes the separation of particles having high molecular weight. These particles additionally show pronounced fluorescent properties.

None of the documents mentioned above describes the use of aluminosilicates (also called adsorption agents hereinbelow) for removing or reducing the content of fluorescent higher molecular weight particles in the polycarbonate.

### SUMMARY OF THE INVENTION

A method for reducing the content of fluorescent particles in polycarbonate is disclosed. The method entails bringing into contact polycarbonate, in the melt or in solution, with aluminosilicate at a temperature and for a time calculated to obtain polycarbonate having fluorescent particles content of 0 to 5 counts/g of polycarbonate. In a preferred embodiment the polycarbonate is passed through a column packed with zeolite.

### DETAILED DESCRIPTION OF THE INVENTION

The object of the present invention was to find an agent which removes the troublesome fluorescent particles without impairing the good properties of polycarbonate. It has therefore been found that, by bringing polycarbonate in molten form or in solution into contact with aluminosilicates, the troublesome fluorescent particles are removed or their concentration markedly reduced and the polycarbonate, in particular also recycling material, may be used again for the production of high-quality products such as lenses, optical data carriers, etc.

The invention provides a method for reducing the content of fluorescent particles in polycarbonate, wherein the polycarbonate, in the melt or in solution, is brought into contact with the aluminosilicate.

To this end, the polycarbonate, in the melt or preferably in solution, is brought into contact with the aluminosilicate, preferably over columns packed with the aluminosilicate, preferably in continuous processes. This continues until the desired quality has been achieved.

Accordingly, polycarbonates that have been freed of fluorescent particles, or whose content of fluorescent particles has been reduced, using aluminosilicates have a particle count of preferably from 0 to 5, particularly preferably from 0.1 to 4 and especially from 1 to 4 counts/g of polycarbonate, measured after dissolution of the polycarbonate in methylene chloride and filtration through a Teflon filter having a pore size of 5 μm at an excitation wavelength of from 400 to 440 nm and with 50× total magnification with an exposure time of 40 ms.

A contiguous fluorescent area on the Teflon filter is automatically detected here under the conditions stated above (wavelength, total magnification, and illumination time) and counted as 1 count. The individual fluorescent particles found on the Teflon filter are counted. In other words the counted particles may be one particle itself or an area of contiguous clustered particles—both will be counted as one count. The total number of fluorescent particles is divided by the mass of the polycarbonate melt weighed out in the respective batch and the particle count (fluorescent) based on 1 gram of polycarbonate (counts/g) is obtained.

The polycarbonate solution is passed over the mentioned columns or filtration devices in solvents or solvent mixtures, particularly preferably in dichloromethane and/or chlorobenzene, at concentrations from 1 to 90 wt. %, preferably from 5 to 50 wt. % and particularly preferably from 5 to 30 wt. % polycarbonate, based on the polycarbonate solution. These columns or filter devices are equipped with aluminosilicate as mentioned above.

When working in solution, the method according to the invention is carried out at temperatures of from 10 to 100° C. The dwell time on the aluminosilicate is from a few seconds to a few hours, depending on the degree of contamination with fluorescent particles and on the adsorption agent. Preferred dwell times are from 5 seconds to 10 minutes. The method is carried out at pressures from 0.5 to 20 bar, preferably at zero pressure or at pressures up to 15 bar.

The polycarbonates to be worked up within the scope of the invention are those which are composed, for example, of the following bisphenols: hydroquinone, resorcinol, dihydroxydiphenyl, bis-(hydroxyphenyl)-alkanes, bis(hydroxy-phenyl)-cycloalkanes, bis-(hydroxyphenyl) sulfides, bis-(hydroxyphenyl) ethers, bis-(hydroxyphenyl) ketones, bis-(hydroxyphenyl)-sulfones, bis-(hydroxyphenyl) sulfoxides, α,α′-bis-(hydroxyphenyl)-diisopropylbenzenes, as well as compounds thereof that are alkylated, alkylated on the ring and halogenated on the ring.

Preferred diphenols are 4,4′-dihydroxydiphenyl, 2,2-bis-(4-hydroxyphenyl)-1-phenyl-propane, 1,1-bis-(4-hydroxyphenyl)-phenyl-ethane, 2,2-bis-(4-hydroxy-phenyl)propane, 2,4-bis-(4-hydroxyphenyl)-2-methylbutane, 1,3-bis-[2-(4-hydroxyphenyl)-2-propyl]benzene (bisphenol M), 2,2-bis-(3-methyl-4-hydroxyphenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfone, 2,4-bis-(3,5-dimethyl-4-hydroxyphenyl)-2-methylbutane, 1,3-bis-[2-(3,5-dimethyl-4-hydroxyphenyl)-2-propyl]-benzene and 1,1-bis-(4-hydroxyphenyl)-3,3,5-trimethylcyclohexane (bisphenol TMC).

Particularly preferred diphenols are 4,4′-dihydroxydiphenyl, 1,1-bis-(4-hydroxy-phenyl)-phenylethane, 2,2-bis-(4-hydroxyphenyl)-propane, 2,2-bis(3,5-dimethyl-4-hydroxyphenyl)-propane, 1,1-bis-(4-hydroxyphenyl)-cyclohexane and 1,1-bis-(4-hydroxyphenyl)-3,3,5-trimethylcyclohexane (bisphenol TMC).

In the case of homopolycarbonates, only one diphenol is used; in the case of copolycarbonates, a plurality of diphenols are used, it being possible, of course, for the bisphenols used, like all the other chemicals and auxiliary substances added to the synthesis, to be contaminated with impurities from their own synthesis, handling and storage, although it is desirable to work with raw materials that are as clean as possible.

The monofunctional chain terminators required to adjust the molecular weight, such as phenol or alkylphenols, in particular phenol, p-tert.-butylphenol, isooctyl-phenol, cumylphenol, chlorocarbonic acid esters thereof or acid chlorides of monocarboxylic acids, or mixtures of such chain terminators, are either fed to the reaction with the bisphenolate or bisphenolates or are added at any desired point in time of the synthesis, provided that phosgene or chlorocarbonic acid end groups are still present in the reaction mixture or, in the case of the acid chlorides and chlorocarbonic acid esters as chain terminators, provided that sufficient phenolic end groups of the polymer that is forming are available. However, the chain terminator or terminators is/are preferably added at a location or at a time at which no more phosgene is present but the catalyst has not yet been added, or they are added before the catalyst, together with the catalyst or in parallel therewith.

Any branching agents or branching agent mixtures that are to be used are added to the synthesis in the same manner, but usually before the chain terminators. Trisphenols, quaternary phenols or acid chlorides of tri- or tetra-carboxylic acids are conventionally used, or mixtures of the polyphenols or of the acid chlorides.

Some of the compounds having three or more phenolic hydroxyl groups which may be used include, for example, phloroglucinol, 4,6-dimethyl-2,4,6-tri-(4-hydroxyphenyl)-heptene-2,4,6-dimethyl-2,4,6-tri-(4-hydroxyphenyl)-heptane, 1,3,5-tri-(4-hydroxyphenyl)-benzene, 1,1,1-tri-(4-hydroxyphenyl)-ethane, tri-(4-hydroxyphenyl)-phenylmethane, 2,2-bis-(4,4-bis-(4-hydroxyphenyl)-cyclohexyl]-propane, 2,4-bis-(4-hydroxyphenyl-isopropyl)-phenol, tetra-(4-hydroxyphenyl)-methane.

Some of the other trifunctional compounds are 2,4-dihydroxybenzoic acid, trimesic acid, cyanuric chloride and 3,3-bis-(3-methyl-4-hydroxyphenyl)-2-oxo-2,3-dihydroindole.

Preferred branching agents are 3,3-bis-(3-methyl-4-hydroxyphenyl)-2-oxo-2,3-dihydroindole and 1,1,1-tri-(4-hydroxyphenyl)-ethane.

Polycarbonates, their preparation, possible additives and their use are described, for example, in WO-A 01/05866, WO-A 01/05867 and EP-A 1 249 463.

Suitable aluminosilicates include zeolites and sheet silicates. Suitable zeolites are in particular compounds of the general formula (I)

M_{2/O}.Al₂O₃.xSiO₂.yH₂O (I)

wherein

M represents protons or metal cations of groups Ia, IIa, IIIa, IVa, Va, VIa, VIIa, VIIIa, Ib, IIb, IIIb and IVb, preferably protons or metal cations of groups Ia, IIa, IIb, IIIb, IVa and IVb, particularly preferably

protons or metal cations of groups Ia, IIa, IIb and IIIb, most particularly preferably protons or the cations Na⁺, K⁺, Cs⁺, Ca²⁺, Mg²⁺, Zn²⁺, La²⁺, Pr³⁺ and Ce³⁺,

n represents the valence of the cation,

x represents the molar ratio SiO₂/Al₂O₃, wherein x may be a number from 1.0 to 50.0, preferably from 2.0 to 25.0, and

y represents a number from 0 to 9.

Suitable for the method according to the invention are zeolites having the structure A,X,Y (Faujasite type), L, ZSM 5,11; 22,23, mordenite, offretite, phillipsite, sodalite, omega and zeolite-like materials such as AlPOs and SAPOs,

particularly suitable are zeolites having the structure A, X, Y (Faujasite type), ZSM 5, 11; mordenite, offretite, omega and SAPO 5 and 11,

most particularly suitable are zeolites having the structure A, X, Y (Faujasite type), ZSM 5 and mordenite.

The sheet silicates that may be used according to the invention are known as such in the literature, see e.g. Kirk-Othmer “Encyclopedia of Chemical Technology” 2nd Ed. 1964, Vol. 5, p. 541-561.

Suitable for the process according to the invention are, as classified in the mentioned article, for example kaolin types, such as kaolinite, dickerite, nacrite (all Al₂O₃.2SiO₂.2H₂O) or anauxite (Al₂O₃.3SiO₂.2H₂O) or halloysite (Al₂O₃.2SiO₂.2H₂O) or endellite (Al₂O₃.2SiO₂.4H₂O) as well as the spinel types prepared from kaolin types by heating.

Also serpentine types, in which—starting from the kaolin types—3 Mg ions have replaced 2 Al ions (Mg₃Si₂O₅(OH)₄). The serpentine types also include amesite (−(Mg2AI)SiAl)05(OH)4) and cronstedite (Fe2+Fe3+)(SiFe3+)O5(OH)4) as well as chamosite (Fe²⁺, Mg)_{2.3}(Fe³⁺ Al)_{0.7}]

(Si_{1.14}Al_{0.86})05(OH)₄, as well as in some cases synthetically obtainable nickel or cobalt species.

It is also possible to use aluminosilicates of the montmorillonite type, such as, for example,

montmorillonite [Al_{1.67}Mg_{0.33}(Na_{0.33})Si₄O₁₀(OH)₂

beidellite Al_{2.17}(Al_{0.33}(Na_{0.33})Si_{3.17}]O₁₀(OH)₂

nontronite Fe³⁺[Al_{1.67}(Na_{0.33})Si_{3.67}]O₁₀(OH)²

hectorite Mg_{2.67}Li_{0.33}(Na_{0.33})Si₄0₁₀(OH,F)₂

saponite Mg_{3.0}[Al_{0.33}(Na_{0.33})Si_{3.67}]O₁₀(OH)₂

sauconite [Zn_{1.48}Mg_{0.14}Al_{0.74}Fe^{3+][Al}_{0.99}Si_{3.01}]O₁₀(OH)₂X_{0.33}

as well as Cu²⁺—, Co²⁺—, Ni²⁺-containing types (X=halogen), such as volkonskoite, medmontite or pimelite.

Such sheet silicates may be used on their own or in the form of a mixture of two or more types and may contain the impurities customary in such natural products, such as those which are customary in, for example, bentonite (montmorillonites with residues of feldspar, quartz, etc.).

Preference is given to the aluminas described as “montmorillonite types”, particularly preferably to montmorillonite itself.

The described aluminosilicates may be used in natural form, in the partially dried state or optionally with acid activation. The acid activation is carried out by treatment with acids, preferably mineral acids.

It is also possible to use any desired mixtures of the above-mentioned zeolites and/or sheet silicates.

Layers of aluminosilicates that are suitable according to the invention are columns, tubes or other containers charged with the aluninosilicates to be used according to the invention.

The amount of aluminosilicates per litre of polycarbonate solution is preferably from 0.01 g to 100 g, especially from 0.1 g to 20 g, more aluminosilicate being required in the case of a more highly concentrated polycarbonate solution than in the case of a less concentrated solution. The concentration of polycarbonate in the polycarbonate solution is generally from 1 to 30 wt. %, preferably from 5 to 25 wt. % polycarbonate.

Suitable solvents for the solutions of the polycarbonates to be purified are, inter alia, those used in the preparation of the polycarbonates, that is to say preferably CH₂Cl₂, chlorobenzene and mixtures thereof. Other suitable solvents are ethers, such as, for example, tetrahydrofuran.

Concentration of the solvents by evaporation may be carried out in a known manner by means of evaporation extruders at temperatures of from 60° C. to 350° C.

The isolation of the polycarbonates purified according to the invention is carried out either after concentration of the solution by evaporation via the melt and subsequent granulation, or after precipitation from the solution by filtration and drying in known apparatuses. However, the aluminosilicates used for the purification are separated from the purified polycarbonate solutions beforehand in a known manner. This may be carried out, for example, by filtration over folded filters or bag filters or by centrifugation.

The polycarbonates purified by the method according to the invention are practically free of organic fluorescent particles, which have formed as a result of subjecting the polycarbonate to thermal load, or the content thereof has been markedly reduced. The particles are characterized by a higher modulus and a greater hardness that those of the matrix material (polycarbonate). The hardness measuring using a Nanoindenter of Hysitron company of the particles is up to about 0.3 GPa higher than that of the matrix.

The polycarbonates purified and isolated by the method according to the invention have an extremely low content of particles which have formed as a result of thermal damage and may therefore advantageously be used wherever a uniform, good property profile and processing at extremely high temperatures—optionally with the application of a vacuum—to form molded bodies with high geometric complexity or high quality is required. The polycarbonates thus treated may accordingly be used in particular in the field of electronics and optics, for example for optical disks, light-scattering disks, lenses, etc.

After the adsorption agents have been separated off, but before the polycarbonates are isolated, the polycarbonates purified according to the present invention may be provided with additives conventional for polycarbonates, such as stabilisers, mold release agents, antistatics, flame retardants and/or colour concentrates, in the conventional amounts. However, it is also possible for the additives to be added to the polycarbonates after they have been isolated, in the course of the production of molded articles.

This is carried out in a known manner by means of known machines, for example at temperatures of from 200° C. to 360° C., for example in internal kneaders, extruders or twin-screw extruders, by melt compounding or melt extrusion.

The additives may be added in a known manner either in succession or simultaneously, at room temperature or at elevated temperature.

The polycarbonates purified by the method according to the invention may be used for making molded articles of any kind, not only, as already mentioned, in the field of electronics and optics but also in the field of film production.

### EXAMPLES

In the Examples which follow there was used an aromatic polycarbonate which is based on bisphenol A and tert.-butylphenol as end group and which has a solution viscosity of about 1.20, measured in dichloromethane (Ubbelohde capillary viscometer) at a concentration of 0.5 g/l and a temperature of 25° C. In order to simulate thermal processing steps, the polycarbonate was tempered in air with a metal stirrer for 2 hours at 350° C.

### Method for Determining the Content of Fluorescent Particles:

The content of fluorescent particles was analysed by filtering the polycarbonate sample in question (50 g), dissolved in dichloromethane (LiChrosolv; Merck: 1.06044 K33506244 430) (700 ml), through a Teflon filter membrane (Bohlender GmbH, D-97847 Grünsfeld) having a pore size of 5 μm. The filter disks were dried in vacuo and protected from ambient dust by a cover. After filtration, the filter surface was studied (scanned) by means of an Axioplan 2 fluorescent microscope from Zeiss A G, Germany. It was operated with an excitation wavelength of from 400 to 440 nm, an exposure time of 40 ms per scan and 50× total magnification. The fluorescent particles were detected and the data was evaluated by means of image processing software (KS 300 3.0 from Zeiss A G). Only particles having a characteristic color were counted, that is to say other particles, such as, for example, dust, were not taken into account (determined according to the HSI colour model, see below). The color parameters for recognizing the fluorescent particles were so adjusted that they corresponded with the parameters of the particles found in the case of flow disturbances in optical disks. Scanning of the surface of the filter was carried out automatically via a computer-controlled specimen stage (Zeiss A G).

The individual fluorescent particles on the Teflon filter were counted. The total number of fluorescent particles was divided by the weight of the polycarbonate melt weighed into the particular batch in question, and the (fluorescent) particle count based on 1 gram (counts/g) was obtained.

### Example 1

25 g of the above-mentioned polycarbonate were dissolved in 950 ml of dichloromethane and passed over a column (diameter 30 mm; height of the adsorption material 200 mm; bottom with size 0 ceramics frit) packed with zeolite (zeolite Na—Y from Bayer A G, previously dried at 400° C. for 3 hours). Rinsing was then carried out with 500 ml of dichloromethane. The solution was concentrated to 500 ml. In order to free the solution of suspended zeolite particles, the solution was centrifuged in an Eppendorf laboratory centrifuge at 4000 rpm and then filtered over a Teflon filter membrane (Bohlender GmbH, D-7847 Grünsfeld, pore size 5 μm, depth 1 mm). Evaluation of the fluorescent particles retained on the filter was carried out as described above by means of automatic detection with a fluorescent microscope with 50× total magnification. A particle count of 3.56 counts/g was obtained as the result of the fluorescent measurement.

### Example 2 (Comparison Example)

50 g of the above-mentioned polycarbonate were dissolved in 700 ml of dichloromethane and then filtered over a folded filter. Treatment with zeolite was not carried out. The solution was then filtered over a Teflon filter membrane (see Example 1). Evaluation of the particles retained on the filter was carried out as described above by means of automatic detection with a fluorescent microscope at 50× total magnification. 8.68 counts/g fluorescent particles were obtained.

### Example 3 (Comparison Example)

The procedure of Example 1 was followed, but the polycarbonate was passed over an unpacked column and then centrifuged. Treatment with zeolite was not carried out.

The solution was then filtered over a Teflon filter membrane (see Example 1) as described in Example 1. Evaluation of the particles retained on the filter was carried out as described above by means of automatic detection with a fluorescent microscope at 50× total magnification. Particle count: 238.2 counts/g fluorescent particles.

It will be seen that all the polycarbonates that were not treated with adsorption agent have a markedly higher content of fluorescent particles.

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A method for reducing the content of fluorescent particles in polycarbonate comprising bringing into contact polycarbonate, in the melt or in solution, with aluminosilicate at a temperature and for a time calculated to obtain polycarbonate having fluorescent particles content of 0 to 5 counts/g of polycarbonate.

2. The method of claim 1 wherein the aluminosilicate is a member selected from the group consisting of zeolite and sheet silicate.

3. The method of claim 1 wherein the obtained polycarbonate has fluorescent particle content of 0.1 to 4 counts/g.

4. A method for reducing the content of fluorescent particles in polycarbonate comprising passing polycarbonate, in the melt or in solution, through a column packed with aluminosilicate at a temperature and for a time calculated to obtain polycarbonate having fluorescent particles content of 0 to 5 counts/g of polycarbonate.
